(19) United States
(12) Patent Application Publication
(10) Pub. No.: US 2019/0095388 A1
(43) Pub. Date: Mar. 28, 2019

(54) CONTACT INFORMATION DISCOVERY AND LABEL BROADCASTING ENGINE

(71) Applicant: Vishal GUPTA, Delhi (IN)

(72) Inventor: Vishal GUPTA, Delhi (IN)

(21) Appl. No.: 16/085,594

(22) PCT Filed: Feb. 24, 2017
(86) PCT No.: PCT/IB2017/051056

§ 371 Date: Sep. 17, 2018

(30) Foreign Application Priority Data
Mar. 16, 2016 (IN) 201611009229

(51) Int. Cl. G06F 16/23; G06F 16/955; G06F 16/27

(52) U.S. Cl. CPC G06F 16/2379; G06F 16/27; G06F 16/955

(57) ABSTRACT

The present invention is directed to updating at least one attributeof contact information retrieved from multiplecrowd-sourced/shared/private contact directories, and broadcasting the updated at least one attribute to the multiplecrowd-sourced/shared/private contact directories.

The present application claims the benefit to Indian Patent Application No. 201611009229 filed on 16'th Mar. 2016.

### FIELD OF INVENTION

The present invention is directed contact directories and contact information of one or more contacts stored therein. The present disclosure further relates to discovery of contact attribute values of a contact by the contact, and updation, by the contact, of at least one label of one or more contact attributes of the discovered contact attribute values.

### BACKGROUND

The background description includes information that may be useful in understanding the present invention. It is not an admission that any of the information provided herein is prior art or relevant to the presently claimed invention, or that any publication specifically or implicitly referenced is prior art.

In existing mobile/smart phones/devices, each device can be configured to store one or more contact directories such as one directory of office colleagues, another of family members, and yet another of social friends, each of which may have contact information of one or more common people/members as well. Such contact directories may also be crowd-sourced, i.e., apart from being stored/developed on the local mobile device, contact directories shared by different users can also be stored on say a common global contact directory database(s) to enable users of the system to retrieve such shared contact directories of which they form part. For instance, user A can have 3 contact directories (family, office, social), each of which can be shared by the user A such that they are accessible/stored at the common global contact directory database such that if one of the 3 contact directories has a user B as a member, user B can automatically/manually retrieve the respective contact directory from the common global contact directory database so as to be able to view the contact directory(ies) that he/she forms a part of. Likewise, user A can also view all contact directories of user B that store users' A contact information.

However, one problem in the above-proposed system is that it is possible that different users store contact information of a given user differently in their respective contact directories. For instance, users A, B, and C may all store (in say their respective contact directories), contact information of user D, however, information being stored may be different. For instance, user A may categorize/label user's D mobile phone number as an Office/Work Number, wherein user B may categorize/label the number as a Personal/Home Number. Likewise, user C may actually associate additional phone numbers with the mobile number of user D, which additional phone numbers may actually be obsolete, and therefore need to be discarded.

The problem is more complicated when different public users are storing different information of an entity and there are privacy and security considerations passing the information of the entity to the public.

There is therefore a need in the art for a system and method that enables easy correction of contact information labels using crowd-sourcing.

### SUMMARY

The present invention is directed to contact directories and contact information of one or more contacts stored therein. The present disclosure further relates to discovery of contact attribute values of a contact by the contact, and updation, by the contact, of at least one label of one or more contact attributes of the discovered contact attribute values. The present disclosure further provides a method and system for building a crowd-sourcing engine for discovery of contact information and label correction.

In an aspect, the present disclosure relates to a system for contact information discovery and discovery-based label updation comprising:a non-transitory storage device having embodied therein one or more routines operable to facilitate contact discovery and discovery-based label updation; andone or more processors coupled to the non-transitory storage device and operable to execute the one or more routines, wherein the one or more routines include:a contact information discovery module, which when executed by the one or more processors, discovers, using a unique identifier of a contact, from a plurality of contact directories storing instances of the unique identifier of the contact, contact information pertaining to the contact, said contact information comprising values for a plurality of contact attributes, wherein said plurality of contact directories storing the unique identifier of the contact comprise at least one crowd sourced shared contact directory having the contact, and wherein the at least one crowd sourced shared contact directory is crowd sourced so as to discover new contacts automatically based on actions of multiple contacts that are already a part of the shared contact directory;a contact information label updation module, which when executed by the one or more processors, enables updation of a label of at least one contact attribute of the plurality of contact attributes based on the value of the at least one contact attribute; and a label update transmission module, which when executed by the one or more processors, transmits updated labels such that the labels are updated only in such contact directories that have the corresponding value of the at least one contact attribute.

In an aspect, the unique identifier can be selected from any or a combination of phone number of the user, name of the user, email address of the user, social media handle, and a contact identifier associated with the user while registering with the system. In another aspect, the plurality of contact attributes can be selected from any or a combination of mobile phone number, landline phone number, social media handle, fax number, email address, physical address, first name, last name, middle name, designation, gender, and website link. In yet another aspect, the label updation can include any or a combination of change of a contact attribute value from valid to invalid, discard action on a contact attribute value, change in type of a contact attribute based on its value, and change in privacy/visibility type of a contact attribute based on its value.

In an aspect, the contact information label updation module may not allow updation of value of any contact attribute. In another aspect, the contact attributes values can be processed so as to enable the contact information label updation module to receive only unique contact attribute values. In another aspect, at least one of the plurality of contact directories storing instances of the unique identifier of the contact is not shared with the contact.

In another aspect, the present disclosure relates to a method for contact information discovery and discovery-based label updation, said method comprising the steps of:discovering, at a computing device, using a unique identifier of a contact, from a plurality of contact directories storing instances of the unique identifier of the contact, contact information pertaining to the contact, said contact information comprising values for a plurality of contact attributes, wherein said plurality of contact directories storing the unique identifier of the contact comprise at least one crowd sourced shared contact directory having the contact, and wherein the at least one crowd sourced shared contact directory is crowd sourced so as to discover new contacts automatically based on actions of multiple contacts that are already a part of the shared contact directory; enabling, at the computing device, updation of a label of at least one contact attribute of the plurality of contact attributes based on the value of the at least one contact attribute; andtransmitting, from the computing device, updated labels such that the labels are updated only in such contact directories that have the corresponding value of the at least one contact attribute.

In an aspect, the computing device can be mobile phone of the contact. In another aspect, the at least one crowd sourced shared contact directory can be stored at a centralized server that is accessible to all contacts that form part of the the at least one crowd sourced shared contact directory. In yet another aspect, one or more contacts that form part of the contact directories in which updated labels are reflected can be intimated when such updation is performed.

It is to be noted that although the present disclosure has been explained with reference to a contact of a user/natural person, it should be appreciated that the contact per se could also be an entity/device having a unique address/identifier instead of being a natural person, wherein, for instance, the entity/device could be a refrigerator, television, a network security device, a smart device connected to a network, or an IoT (Internet of Things) device.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 illustrates an exemplary architecture showing shared and private contact directories across two users, in which exemplary architecture aspects of the present disclosure can be implemented.

FIG. 2 illustrates exemplary functional modules of the proposed system in accordance with an embodiment of the present disclosure.

FIG. 3A illustrates discovery of contact attribute values for a contact that are stored across one or more contact directories that the contact forms part of based on a unique identifier of the contactin accordance with an embodiment of the present disclosure.

FIG. 3B illustrates updation of labels of one or more contact attributes based on the discovered contact attribute values in accordance with an embodiment of the present disclosure.

FIG. 3C illustrates how updated labels of one or more contact attributes are transmitted to respective contact directories that store the contact attribute values of which the contact attributes are updated.

FIG. 4 illustrates an exemplary representation that enables discovery of contact information of a given user across multiple contact directories to enable the user to modify at least one attribute of the discovered contact information in accordance with an embodiment of the present disclosure.

FIG. 5 illustrates a flow diagram showing discovery of contact attribute values of a contact from one or more contact directories based on a unique identifier of the contact,and updation of labels pertaining to contact attributes of the discovered contact attribute values based on the contact attributes of the discovered contact attribute values in accordance with an embodiment of the present disclosure.

FIG. 6 illustrates an exemplary representation showing how a user David Musk can create one or more CCs using aggregate contact information that he has discovered from a plurality of CDs that he forms part of or has access to.

### DETAILED DESCRIPTION

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various terms are used herein. To the extent a term used in a claim is not defined below, it should be given the broadest definition persons in the pertinent art have given that term as reflected in printed publications and issued patents at the time of filing.

In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

Throughout the following discussion, numerous references will be made regarding servers, services, interfaces, engines, modules, clients, peers, portals, platforms, or other systems formed from computing devices. It should be appreciated that the use of such terms is deemed to represent one or more computing devices having at least one processor (e.g., ASIC, FPGA, DSP, x86, ARM, ColdFire, GPU, multi-core processors, etc.) configured to execute software instructions stored on a computer readable tangible, non- transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, a circuit- switched network, the Internet, LAN, WAN, VPN, or other type of network.

The terms “configured to” and “programmed to” in the context of a processor refer to being programmed by a set of software instructions to perform a function or set of functions.

The following discussion provides many example embodiments. Although each embodiment represents a single combination of components, this disclosure contemplates combinations of the disclosed components. Thus, for example, if one embodiment comprises components A, B, and C, and a second embodiment comprises components B and D, then the other remaining combinations of A, B, C, or D are included in this disclosure, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, numerical parameters expressing quantities are used. It is to be understood that such numerical parameters may not be exact, and are instead to be understood as being modified in some instances by the term “about.” Accordingly, in some embodiments, a numerical parameter is an approximation that can vary depending upon the desired properties sought to be obtained by a particular embodiment.

Unless the context dictates the contrary, ranges set forth herein should be interpreted as being inclusive of their endpoints and open-ended ranges should be interpreted to include only commercially practical values. The recitation of ranges of values herein is merely intended to serve as a shorthand method of referring individually to each separate value falling within the range. Unless otherwise indicated herein, each individual value within a range is incorporated into the specification as if it were individually recited herein. Similarly, all lists of values should be considered as inclusive of intermediate values unless the context indicates the contrary.

Groupings of alternative elements or embodiments of the inventive subject matter disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

This disclosure allow for construction or configuration of a computing system or device to operate on vast quantities of digital data, beyond the capabilities of a human. The computing system or device is able to manage the digital data in a manner that could provide utility to a user of the computing system or device that the user would lack without such a tool.

The present invention is directed contact directories and contact information of one or more contacts stored therein. The present disclosure further relates to discovery of contact attribute values of a contact by the contact, and updation, by the contact, of at least one label of one or more contact attributes of the discovered contact attribute values.

In an aspect, the present disclosure relates to a system for contact information discovery and discovery-based label updation comprising:a non-transitory storage device having embodied therein one or more routines operable to facilitate contact discovery and discovery-based label updation; andone or more processors coupled to the non-transitory storage device and operable to execute the one or more routines, wherein the one or more routines include:a contact information discovery module, which when executed by the one or more processors, discovers, using a unique identifier of a contact, from a plurality of contact directories storing instances of the unique identifier of the contact, contact information pertaining to the contact, said contact information comprising values for a plurality of contact attributes, wherein said plurality of contact directories storing the unique identifier of the contact comprise at least one crowd sourced shared contact directory having the contact, and wherein the at least one crowd sourced shared contact directory is crowd sourced so as to discover new contacts automatically based on actions of multiple contacts that are already a part of the shared contact directory;a contact information label updation module, which when executed by the one or more processors, enables updation of a label of at least one contact attribute of the plurality of contact attributes based on the value of the at least one contact attribute; and a label update transmission module, which when executed by the one or more processors, transmits updated labels such that the labels are updated only in such contact directories that have the corresponding value of the at least one contact attribute.

In an aspect, the unique identifier can be selected from any or a combination of phone number of the user, name of the user, email address of the user, social media handle, and a contact identifier associated with the user while registering with the system. In another aspect, the plurality of contact attributes can be selected from any or a combination of mobile phone number, landline phone number, social media handle, fax number, email address, physical address, first name, last name, middle name, designation, gender, and website link. In yet another aspect, the label updation can include any or a combination of change of a contact attribute value from valid to invalid, discard action on a contact attribute value, change in type of a contact attribute based on its value, and change in privacy/visibility type of a contact attribute based on its value.

In an aspect, the contact information label updation module may not allow updation of value of a contact attribute. In another aspect, the contact attributes values can processed so as to enable the contact information label updation module to receive only unique contact attribute values. In another aspect, at least one of the plurality of contact directories storing instances of the unique identifier of the contact is not shared with the contact.

In another aspect, the present disclosure relates to a method for contact information discovery and discovery-based label updation, said method comprising the steps of:discovering, at a computing device, using a unique identifier of a contact, from a plurality of contact directories storing instances of the unique identifier of the contact, contact information pertaining to the contact, said contact information comprising values for a plurality of contact attributes, wherein said plurality of contact directories storing the unique identifier of the contact comprise at least one crowd sourced shared contact directory having the contact, and wherein the at least one crowd sourced shared contact directory is crowd sourced so as to discover new contacts automatically based on actions of multiple contacts that are already a part of the shared contact directory; enabling, at the computing device, updation of a label of at least one contact attribute of the plurality of contact attributes based on the value of the at least one contact attribute; andtransmitting back, from the computing device, updated labels such that the labels are updated only in such contact directories that have the corresponding value of the at least one contact attribute.

In an aspect, the computing device can be mobile phone of the contact. In another aspect, the at least one crowd sourced shared contact directory can be stored at a centralized server that is accessible to all contacts that form part of the the at least one crowd sourced shared contact directory. In yet another aspect, one or more contacts that form part of the contact directories in which updated labels are reflected can be intimated when such updation is performed.

The present disclosure relates to a system that enables automatic retrieval/discovery, for a given user, of all contact information stored across shared/private contact directories (of different people/users) that the given user is listed in, and enables the given user to then amend label of at least one attribute of the retrieved/discovered contact information such that the amended label can be broadcasted/updated across the shared/private contact directories.

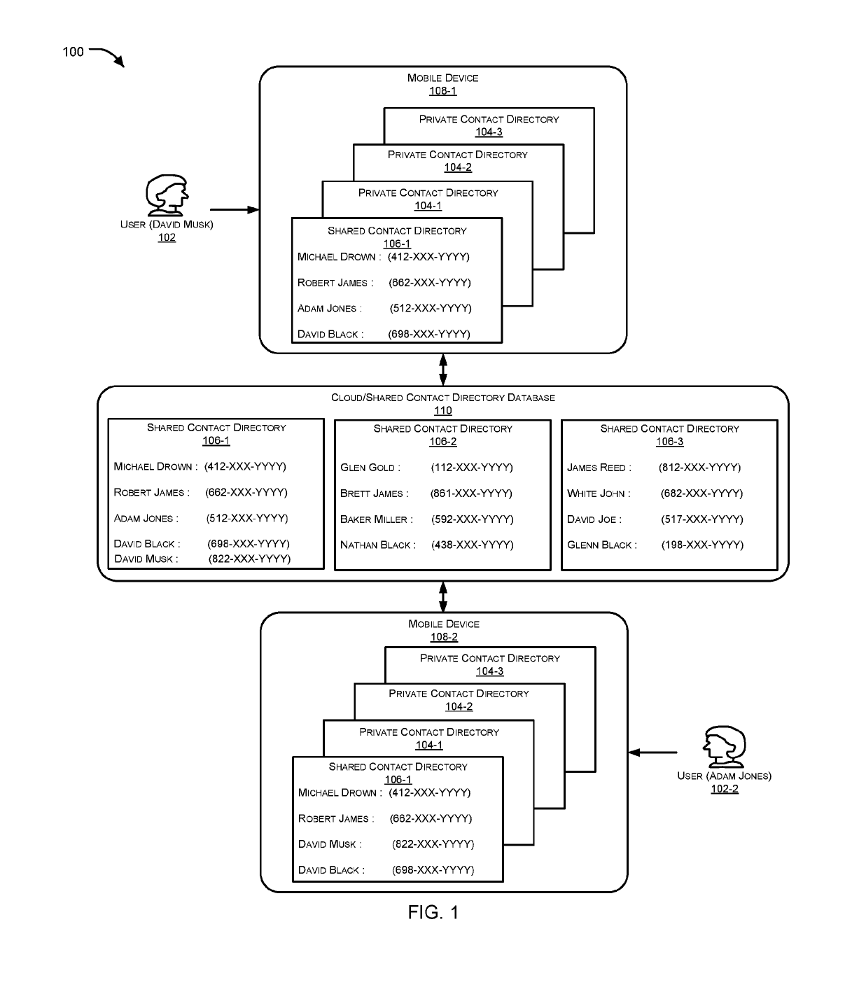

FIG. 1 illustrates an exemplary architecture 100 showing shared and private contact directories across two users, in which exemplary architecture aspects of the present disclosure can be implemented.

As shown, user 102-1 (David Musk) can have one or more contact directories (CDs) 104/106, one or more of which may be private CDs 104 while other may be shared CDs 106, wherein the private CDs 104 can be accessible/viewable only to the owner of the CD and therefore stored only on the mobile phone/smart phone 108 of the respective owner/creator. Similarly, user 102-2 (Adam Jones) can also have one or more CDs 104/106.

As shown in the example, shared CDs 106 (also referred to as shared phone books) can be configured such that they are stored on a common/centralized server/cloud 110 so that all contacts that form part of the respective CD 106 can view the corresponding shared CD 106, and can also add new contacts, which can be then be seen/viewed by other contacts of the CD 106 in which the new contact is added.

As shown, user 102-1 has three private CDs 104-1, 104-2, and 104-3, and one shared CD 106-1, which shared CD 106-1 is also stored on cloud 110 along with other shared CDs 106-2, 106-3, . . . , 106-N. As the shared CD 106-1 also has user 102-2 (Adam Jones) as a contact, user 102-2 (Adam Jones) also has access to the shared CD 106-1, which shows the contact information of user 102-1 (David Musk).

It would be appreciated that users 102 can either view copies of the shared CDs 106 on their mobile devices 108 by accessing the copies stored on cloud 110 or can, along with having copies on the cloud/server 110, also store local copies of the shared CD 106, wherein any change (such as addition of new contacts, or change in contact information of one or more contacts) performed to a shared CD 106 can be synchronized across all copies/instance of the shared CD 106. Therefore any manner/mode/mechanism using which shared CDs 106 are stored, created, modified, updated, and synchronized is completely within the scope of the present disclosure.

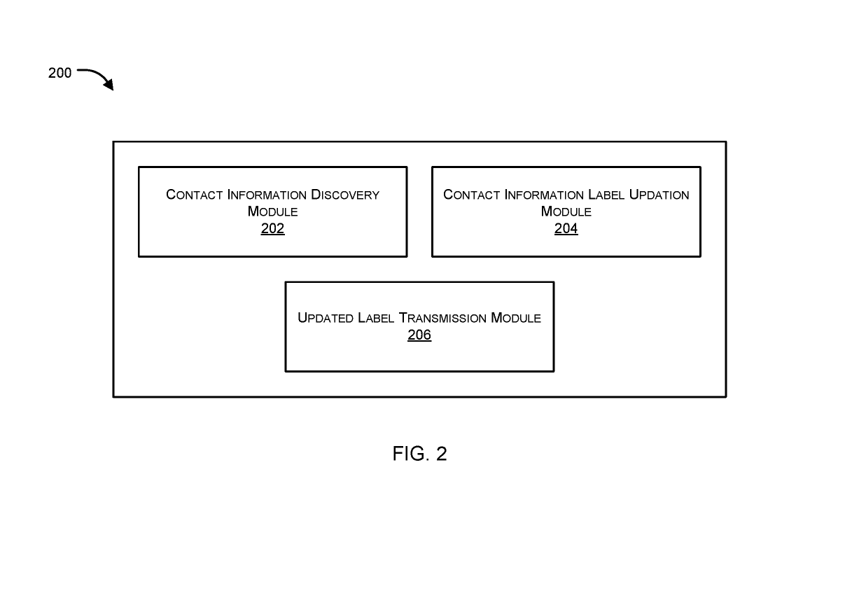

FIG. 2 illustrates exemplary functional modules of the proposed system 200 in accordance with an embodiment of the present disclosure. In an aspect, system 200 of the present disclosure can be configured on a mobile device such as a mobile/smart phone of a contact (also sometimes interchangeably referred to as a user), such device having a non-transitory storage device having embodied therein one or more routines operable to facilitate contact discovery and discovery-based label updation; and having one or more processors coupled to the non-transitory storage device and operable to execute the one or more routines.

In an aspect, the one or more routines of the present disclosure can include a contact information discovery module 202, which when executed by the one or more processors, discovers, using a unique identifier of a contact, from a plurality of contact directories storing instances of the unique identifier of the contact, contact information pertaining to the contact, said contact information comprising values for a plurality of contact attributes, wherein said plurality of contact directories storing the unique identifier of the contact comprise at least one crowd sourced shared contact directory having the contact, and wherein the at least one crowd sourced shared contact directory is crowd sourced so as to discover new contacts automatically based on actions of multiple contacts that are already a part of the shared contact directory. The routines can further include a contact information label updation module 204, which when executed by the one or more processors, enables updation of a label of at least one contact attribute of the plurality of contact attributes based on the value of the at least one contact attribute. The routines can finally include a updated label transmission module 206, which when executed by the one or more processors, transmits updated labels such that the labels are updated only in such contact directories that have the corresponding value of the at least one contact attribute.

In an aspect, the unique identifier can be selected from any or a combination of phone number of the user, name of the user, email address of the user, social media handle, and a contact identifier associated with the user while registering with the system.

In another aspect, the plurality of contact attributes are selected from any or a combination of mobile phone number, landline phone number, social media handle, fax number, email address, physical address, first name, last name, middle name, designation, gender, and website link.

In yet another aspect, the label updation can include any or a combination of change of a contact attribute value from valid to invalid, discard action on a contact attribute value, change in type of a contact attribute based on its value, and change in privacy/visibility type of a contact attribute based on its value.

In yet another aspect, the contact information label updation modulemay not allow updation of value of any contact attribute.

In an aspect, the contact attributes values can be processed so as to enable the contact information label updation module to receive only unique contact attribute values.

In another aspect, at least one of the plurality of contact directories storing instances of the unique identifier of the contact may not be shared with the contact. For instance, in case 5 CDs store instance of a contact (say David Musk), preference of owner/creator of one of the 5 CDs may be such that his/her CD is not discoverable i.e. when David Musk wishes to retrieve all CDs that he forms a part of (i.e. his instance is present), a private/non-discoverable CD may not be discovered due to its nature of viewing/preference of owner the respective CD.

### Contact Information Discovery Module 202

As mentioned above, contact information discovery module 202 can be configured to discover, using a unique identifier (such as mobile phone number or email address) of a contact (such as David Musk), from a plurality of CDs storing instances of the unique identifier of the contact, contact information (having contact attributes and corresponding values thereof) pertaining to the contact, said contact information comprising values for a plurality of contact attributes, wherein said plurality of CDs storing the unique identifier of the contact include at least one crowd sourced shared CD having the contact, and wherein the at least one crowd sourced shared CD is crowd sourced so as to discover new contacts automatically based on actions of multiple contacts that are already a part of the shared CD.

In an exemplary implementation, contact information discovery module 202 of the present disclosure can be configured to, based on a phone number (or email address or URL or any other contact attribute value that uniquely identifies user A) of user A (entered by user A or automatically determined by the discovery module 202), discover/retrievecontact information of user A from one or more shared and/or private CDs that the user A forms part of or has instances of himself/herself. For instance, module 202 of the present disclosure can receive mobile number of user A, and run a search across one or more CDs that it has access to to identify all CDs that store instances of user A. Contact information of user A can then be extracted from the identified/shortlisted CDs and presented to user A, wherein the contact information can include one or more contact attributes such as any or a combination of mobile phone number, landline phone number, social media handle, fax number, email address, physical address, first name, last name, middle name, designation, gender, and website link, along with corresponding values of such contact attributes.

In an aspect, the contact information discovery module 202 can check access rights of user A,and based on the same, retrieve his/her contact information stored in shared CDs or even in private CDs of different users. In an aspect, shared CDs can be stored in a common global contact directory database (such as server/cloud 110 explained above in FIG. 1)(that the proposed system can be operatively coupled), wherein such shared CDs can be crowd-sourced.

In another instance, a user S can store multiple CDs (also commonly referred to as phone books) on his/her mobile/smart phone such as one for family members, another for office colleagues, yet another for social friends, and another for colleague friends, among other like contact directories, each of which can store contact attributes (such as phone number, name, address, email id, URL, website, birthday information, social profile links, among other contact information attributes/parameters) of one or more other users.User S can further be configured to use the proposed system to share (also referred to as crowd-source) one or more CDs and keep the others as private. For instance, a user S may have access to 5 CDs, 3 of may be shared CDs (and accordingly stored on the common global contact directory database), and the other 2 may be private CDs. In this example, the proposed contact information discovery module 202 can, for the given user A, access all contact directories (shared and/or private) that store the contact information (i.e. at least one contact attribute and value thereof) of user A, and retrieve all contact attributes and corresponding values of the user A from the accessed CDs. For instance, user S may store contact information (such as phone number(s), email address, URL, physical address) of user A across 2 CDs (one shared CD and one private CD), and another user T may store contact informationof user A across 3 CDs (shared or private), and yet another user U may store contact informationof user A across 1 CD (shared or private), all of which 6 CDs can therefore be accessed by the proposed contact information discovery module202 to discover/retrieve all contact information attributes and corresponding values of the user A stored in these retrieved CDs, which contact information attributes and values thereof can then bepresented to the user A.

In an aspect, contact information discovery module 202 can discover contact information for user A based on user A's phone number and further based on name of the user i.e. based on a combination of two or more contact attribute values. For instance, contact information discovery module 202 can query a common global contact directory database (storing shared contact directories) as well private CDs using the phone number such as 999-999-1234 as well as name of user A such as “Alan”, and accordingly present all contact information (contact attributes and values thereof) for contacts across shared/private contact directories that have a matching phone number and contact name. Any other parameter can also be used to query the contact directory databases for discovery of contact information about user A, all of which possible parameters/embodiments are well within the scope of the present disclosure.

It should be appreciated that instead of all contact attributes values from being presented to contact whose instance search is being done, only unique values are presented to the contact, i.e. duplication can be removed before being presented to the user. For instance, if user A's instance is being searched across CD's, and two instances of user A store his email address as abc@xyz.com, contact attribute “email address” is presented with value abc@xyz.com is presented only once. However, the module 202 surely keeps track of which all CDs store the same email address value for the “email address” attribute. Such a step can help remove all duplicate attribute values before being reported to the contact/user. Similarly, it is very much possible that for one contact attribute, different CDs store different values. For instance, for “email address” contact attribute, one CD can store abc@xyz.com and another CD can store def@xyz.com, both of which may be valid and correct.

### Contact Information Label Updation Module204

In an aspect, contact information label updation module 204 can enable updation of a label of at least one contact attribute of the plurality of contact attributes based on the value of the at least one contact attribute. For instance, in case, based on execution of module 202, contact A receives 15 contact attribute values of corresponding contact attributes, contact A can update label of one or more contact attributes based on their respective values. It should be appreciated that 15 contact attribute values may correspond to say 5 contact attributes, wherein one or more contact attributes such as “phone number” and “email address” may have multiple values stored across different CDs. For instance, discovered email addresses for a contact A could be abc@xyz.com, def@xyz.com, and aef@xyz.com, one or more of which may be valid/invalid. Such invalid contact attribute values may be desired to be discarded by the contact A by changing the label of the contact attribute. Similarly, different values for contact attribute “phone number” may be 9810617XXX, 9810617YYY, and 9810617ZZZ, wherein contact A may wish to hide (make invisible) the contact attribute having value 9810617ZZZ. Such label updations therefore do not change any value of the contact attribute per se but only instead change type/characteristics/mode of the corresponding contact attribute.

In an aspect, contact attributes can be selected from any or a combination of mobile phone number, landline phone number, social media handle, fax number, email address, physical address, first name, last name, middle name, designation, gender, and website link.In yet another aspect, the label updation can include any or a combination of change of a contact attribute value from valid to invalid (say a particular phone number can be marked as invalid), discard action on a contact attribute value (say a particular email address can be marked as discarded), change in type of a contact attribute based on its value (say a phone number can be changed from “Business type” to “Personal type”), and change in privacy/visibility type of a contact attribute based on its value (say a particular social media handle can be made invisible). Contact information label updation module 204 of the present disclosure therefore may not allow updation of value of any contact attribute.

In an aspect, contact information attribute updation module 204 can be configured to enable user A to view the discovered contact information about himself/herself, and update label of at least one contact attribute of the discovered contact information based on rights accorded to user A by the proposed system. For instance, user A can be allowed to change the label of his/her phone number, wherein in case contact directory CD_5 of user S stores the mobile number of user A as a personal/home phone number, user A can change the same to Office/Work phone number. In an aspect, user A may not be shown the contact directories that he/she forms part of (discovered contact directories) and can only be presented, for instance, all the phone numbers that are associated with user's A phone number. Discovery module of the present invention can therefore only retrieve the phone numbers that are associated with the phone number (of user A) entered/queried by the discovery module. For instance, a first user may store user A's phone number 999-999-1234 as personal number and also store another phone number 888-888-1234 as work number. Similarly, a second user may store user A's phone number 999-999-1234 as work number and also store 2 more phone numbers 777-888-1234 and 777-777-1234 as personal numbers. In such a case, the discovery module can retrieve all these associated numbers and present phone numbers 999-999-1234, 888-888-1234, 777-777-1234, and 777-888-1234 to the user A, which can then enable the user A to either change the label (say from Home to Work or from Work to Private or from Home to Private, or any other combination) or can either discard a given number say 777-888-1234 as being incorrect (or not valid anymore). Any other action on the contact attribute type/characteristic is well within the scope of the present disclosure till the time the user/contact A does not change the contact attribute value per se.

In another aspect, user A can also be presented with all the discovered contact directories (in the form of a list of contact directories) that store user A's contact information so as to enable the user A to update/amend label of at least one allowed/configured contact attribute of the user. In another aspect, user can also make amendments at a CD level, wherein in case 5 CDs (that store user A's contact information) are retrieved by the proposed discovery module, user A can select any given CD and update his/her contact information stored therein, which update can then be reflected in the respective directory by means of the propagation module described below. In an aspect, such updation of contact information in some other user's CD can only be allowed after authentication of user A, and rights to make such changes can be configured either by the system or by the user's whose CD is being updated. Furthermore, such updates may only be possible in shared CD and not in private contact directories.

One should appreciate that labels of attributes that can be updated by user A on discovered contact information about him/her can be defined by the system, and all such attributes are well within the scope of the present disclosure. For instance, in case one discovered/associated contact number of user A is marked as shared, the user A can be allowed to mark it as private.

Also, it should be appreciated that as a contact can have multiple phone numbers associated thereto, all such phone numbers such as phone number_1, phone number_2, and phone number_3 are different contact attributes which would then have values such as 9810617992, 9810617993, and 9810617994 respectively.

### Updated Label Transmission Module 206

In an aspect,module 206 can be configured to transmit updated labels such that the labels are updated only in such contact directories that have the corresponding value of the at least one contact attribute. For instance, in case phone number 9810617992 stored in CD_1 of contact B is discarded by contact A (owner of phone number 9810617992), and, for phone number 9824673432 stored in CD_2 of contact C, the tag is changed by user A (also owner of phone number 9824673432) from Office to Personal, when the label changes are being updated, only CD's that store the contact attributes of whose labels have been changed are updated. For instance, as CD_2 does not store phone number 9810617992 against contact A, it only updates the updated label for contact attribute “phone number” against the phone number 9824673432, and similar action is also takes place for CD_1. Therefore, no any new contact attribute is added or updated, and labels of only those contact attributes are updated in one or more CDs that store such values corresponding to updated contact attributes.

Module 206 can further be configured to submit updated information across shared and/or private contact directories so as to enable change in the label or any other attribute that the user has changed in the discovered contact information. For instance, in case user A marks his/her associated phone number 777-888-1234 as “Discard”, the same can be notified in all the contact directories that store the number 777-888-1234 in association with user A. On the other hand, directories that store the number 777-888-1234 with another user B may not be updated. As mentioned above, certain updates can only be made in shared contact directories that are stored in a common global contact directory database. For instance, in case the user A adds a new email address to his/her contact information, the propagation module 106 can be configured to enable such addition of email to be reflected only in shared contact directories.

The present invention therefore pertains to a contacts management platform with more than one user that is supplemented with a contact discovery module, wherein the discovery module can search for all relevant contacts for a given user A in the universe of contact directories it maintains, and discovers all possible contacts and the contained information about the user. It then aggregates the information and presents the newly discovered information to the User A for classification (labeling) or updation. It then further propagates the updated information or classification tags (using the contact information update propagation module) back to the discovered contacts. The classification tags may include but not limited to Home, Work, Private, Discard etc.

It is to be appreciated that the User A may not be the owner of the other contact directories. The discovered contacts although may relate to the user but the user does not necessarily own the contact information that is present in other's contact directories, wherein the directories may be shared or not shared or even public.The propagation system may further include additional information that can be pushed to the related contacts. The information supplemented may be done by the user or automatically supplemented like time zone, city etc. The propagation may further be limited for certain information to a list of contact owners based on relatedness of the user A to the other users. Contacts discovery may use various methods to match related contacts including a unique identifier like phone, email or other combinations and algorithms using a combination of contact information. In the preferred embodiment, the discovery may be initiated on verification of ownership of the user A of the contact information that is to be searched on the platform. The propagation may include user A context information like phone status about ring, battery, location, security, and privacy settings etc. The proposed system is especially useful to push generic information like user photo, social profiles, and public information such as blog and websites to other users. Further, the proposed system helps eliminate junk information that may be irrelevant by tagging/classifying/labeling. It strikes perfect balance between privacy and authority over the contact information of the user lying in other people's contact directories (shared or private) while minimizing effort on both sides.

It is to be noted that although the present disclosure has been explained with reference to a contact of a user/natural person, it should be appreciated that the contact per se could also be an entity/device having a unique address/identifier instead of being a natural person, wherein, for instance, the entity/device could be a refrigerator, television, a network security device, a smart device connected to a network, or an IoT (Internet of Things) device. For instance, an IoT device may be able to discover its status by sending its unique identifier that may be stored in directories/applications of one or more users of the respective IoT device, wherein label of the discovered status (contact attribute value) may then be changed by the IoT device. For instance, an IoT based Television may, against a time slot of 10 PM to 1 AM, change the label of viewing to A.

It is to be appreciated that although all the functional modules have been shown together, they may exist on different devices. For instance, it may be possible that server/cloud stores implementation for modules 202 and 206 and the local device of the contact stores module 204, and it may also be possible that all the modules are configured on the local device itself. The work/operation may therefore be distributed in any desired manner, and all such implementations are well within the scope of the present disclosure till the time the claimed functionality is being performed/obtained. A distributed database architecture may also be implemented to offload one or more operations involved in implementation of the proposed functional modules. For instance, it may be possible that all the discovered contact information is sent to the contact's device, and the updation and transmission takes place locally itself, post which synchronization is performed to propagate all the changes.

It would be appreciate that many possible scenario may trigger the discovery event or the updation of one or more labels of corresponding contact attributes. Such a process may or may not be continuous and for instance, may have delays.Each update may or may not be notified to the user whose contact directory is being updated, and all such implementations are completely exemplary and based on actual configuration/settings of the proposed system. In an implementation, any new discovery for a contact may in real-time be informed to the contact so that he/she can update label(s) of one or more contact attributes, and a queue may be maintained for such pending label selections.

It is to be appreciated that aspects/features/functionalities the present disclosure can be carried out/implemented across one or more computing devices. For instance, in one embodiment, discovery of aggregate contact information of user A can be performed on the mobile device/phone of the user A, whereas in another embodiment, the discovery step can, per se, be performed on a server/cloud that can, using a unique identifier/phone number of the user A, discover all CDs that the user forms part of, aggregate all contact information retrieved about the user A in such discovered CDs, and present the aggregated contact information to the user A. Similarly, the action of updating labels of contact information attributes based on values thereof can also be performed on any device that is operatively/communicatively coupled with the mobile device of the user A. Therefore, all such implementations of carrying out aspects of the present invention are well within the scope of the present disclosure.

Also, discovery of contact information for a user A may not only be done or triggered manually and can be automatically triggered on occurance of a defined event. Such discovery also need not be exhaustive to retrieve all contact information for a user, and may only be for a part of the contact information, say from specific CDs.

In an aspect, the step of discovery of contact information present about user A across one one or more CDs may be initiated manually by the user A, or by the proposed system/server, or can be automatically initiated whenever there is some new contact information available about user A. For instance, when a new user X joins the proposed system, one or more CDs of user X may become accessible to the system/server/cloud, one or more of which CDs may include new contact information of user A, which new contact information can be shared with user A to enable the user A to change labels of the contact information attributes that form part of the new contact information based on values of such corresponding contact information attributes. Therefore, instead of re-discovering all contact information available about user A from all CDs that store instances of user A, only the new contact information may be filtered/labels as desired by the user A. It would be appreciated that such new contact information stored by CD(s) of user X may not actually have any unique contact information per se but its being referred to as new contact information only because its obtained from user X that has recently joined in the proposed system.

In another exemplary embodiment of the present disclosure, once user A, who has received discovered contact information about himself, updated labels of one or more contact information attributes based on corresponding values thereof, a badge and/or a specific graphical representation such as a tick can be associated with each updated label, which specific graphical representation can be stored locally on the mobile device of the user A or on a server/cloud that stores shared CDs that comprise user A's contact information. Such a graphical representation can help the proposed system confirm that the updated labels are accurate, and can also, in an aspect, use such accuracy confirmation for automatically updating labels of future discovered information. For instance, user A may update label of personal email id (contact information attribute) having value a@gmail.com as “discard”, which updated label can then be represented through a tick representation against the personal email id having value a@gmail.com. Such representation can, as mentioned above, be stored at a server of the proposed system, wherein sooner the server discovers new contact information about user A and determines that the new contact information comprises contact information attribute personal email id having value a@gmail.com, it automatically updates the label of such attribute without sending such discovered information to the user A. It is to be appreciated that these are only exemplary embodiments, and any other implementation that may use a representation against a verified label of a contact information attribute is well within the scope of the present disclosure. In an aspect therefore, updation of the label can be accompanied with association of a graphical representation (can also be referred to a secondary label, which can for instance, be an ASCII character such as a tick mark) with the label (or with the contact information attribute, and therefore location/position of the secondary label is not limited in any manner), said graphical representation being indicative of the updated label being verified by the contact.

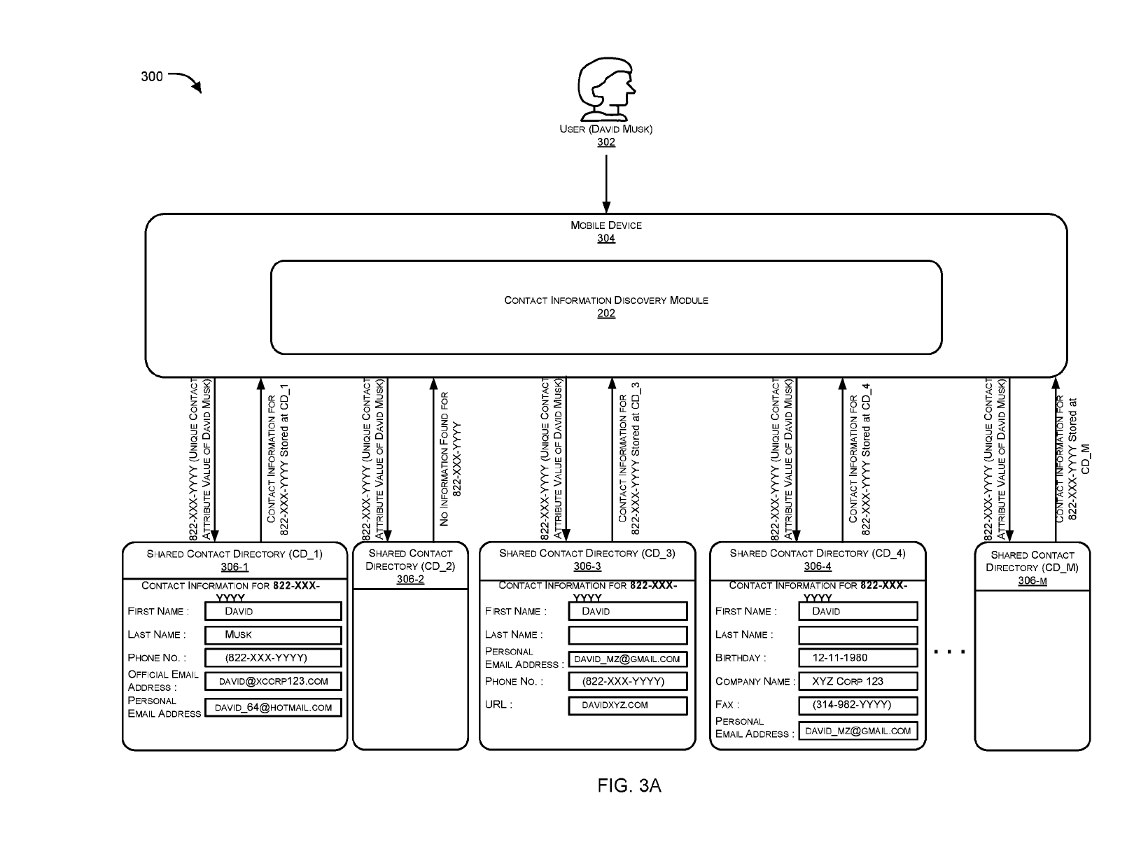

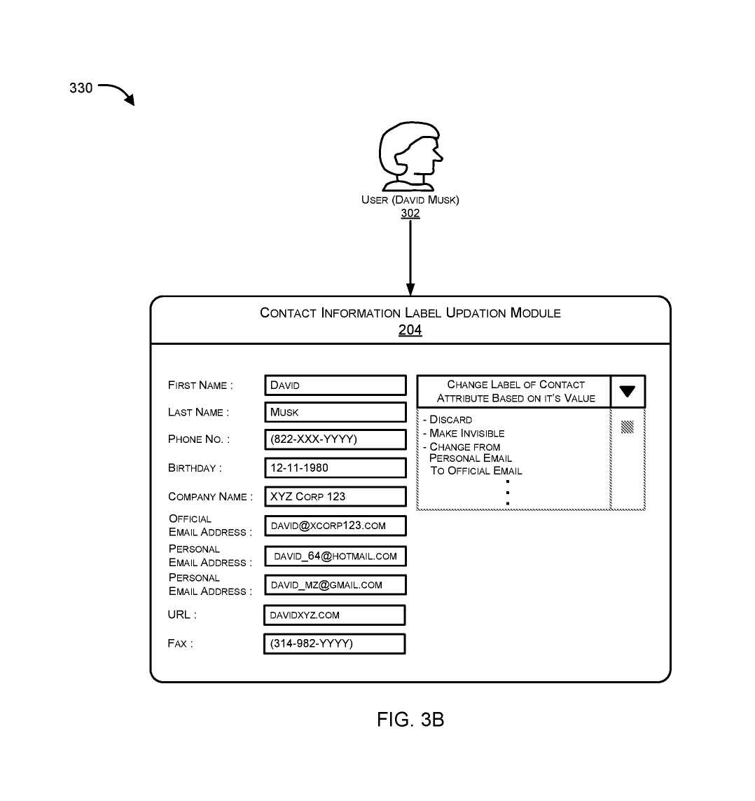

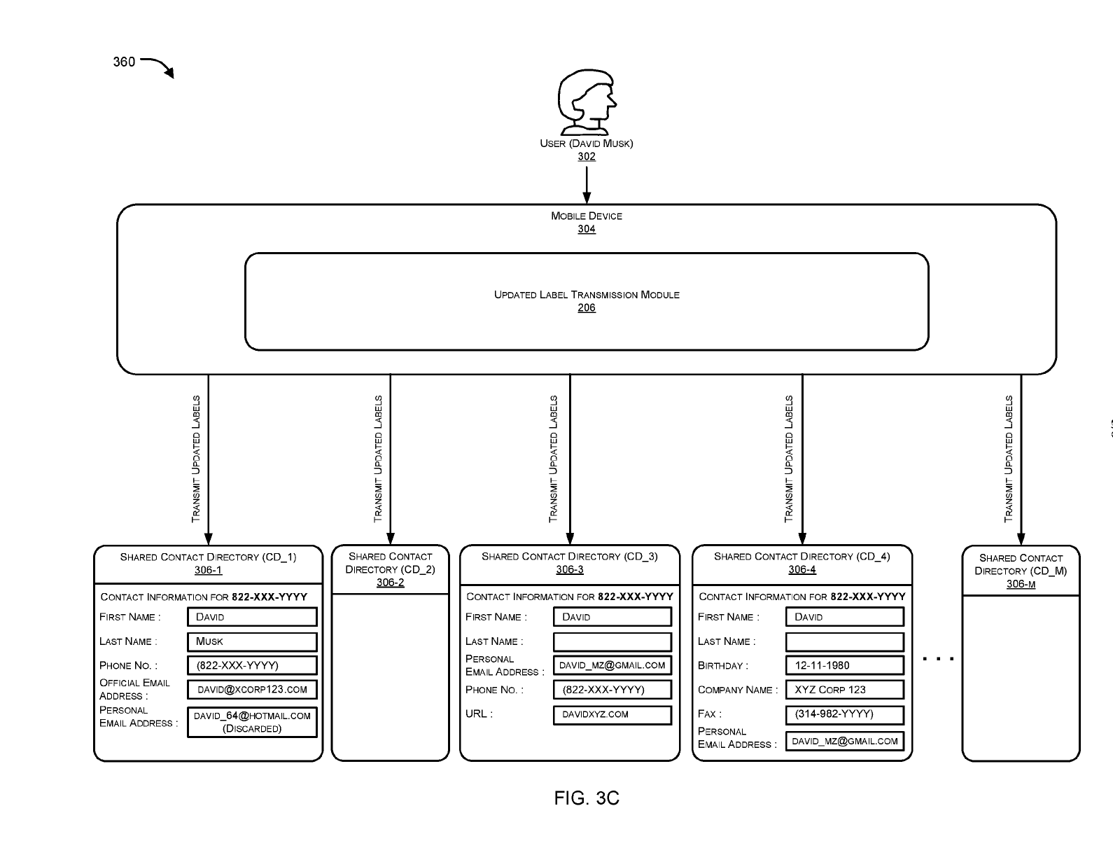

FIG. 3A illustrates discovery of contact attribute values for a contact that are stored across one or more contact directories that the contact forms part of based on a unique identifier of the contactin accordance with an embodiment of the present disclosure. As shown, user 302 having computing device 304 can discover contact information (having one or more contact attributes and corresponding values of such attributes) of himself/herself through the system of the present disclosure by searching, for instance, for presence of one or a combination of identifiers (such as phone number) of the contact across a plurality of shared/private/searchable CDs. As shown, phone number of user 302 can be searched across multiple CDs 306-1, 306-2, . . . , 306-n, collectively referred to CDs 306 hereinafter, wherein CDs 306-1, 306-3, and 306-4 have instances of the phone number of the user 302, and therefore return contact information stored therein. For instance, the proposed system discovers first name, last name, phone number, personal email address, and official email address from CD 306-1, discovers first name, personal email address, phone number, and URL from CD 306-3, and discovers first name, last name, birthdate, personal email address, company name, and fax number from CD 306-4. Such information can be returned back to the computing device 304 of the user 302, wherein in an exemplary implementation, duplicate contact attribute values can be removed and only unique values can be presented to the user as shown in FIG. 3B. In another instance, discovered contact information (including contact attributes and values thereof) can also be normalized/processed automatically before de-duplication and presentation to the user for updation. Such normalization/processing can include formatting, global intelligent lookups to databases, and Artificial-intelligence based processing.

FIG. 3B illustrates updation of labels of one or more contact attributes based on the discovered contact attribute values in accordance with an embodiment of the present disclosure. As shown, once user 302 is presented with multiple contact attributes and values therefore, labels of one or more contact attributes can be changed such as, fax number can be marked as discarded, and personal email address can be marked invisible. Any other change in characteristic/type of contact attribute based on its respective value is completely within the scope of the present disclosure.

FIG. 3C illustrates how updated labels of one or more contact attributes are transmitted to respective contact directories that store the contact attribute values of which the contact attributes are updated. As can be seen, once user 302 has updated one or more labels of corresponding contact attributes, such updated labels can be transmitted back CDs where corresponding contact attributes are stored. For instance, although instance of phone number of user 302 is present across 3 CDs, only CD 306-4 has the fax number, and therefore discarded label for the fax number would only be updated in CD 306-4 and not in other CDs where instance of the user 302 is present.

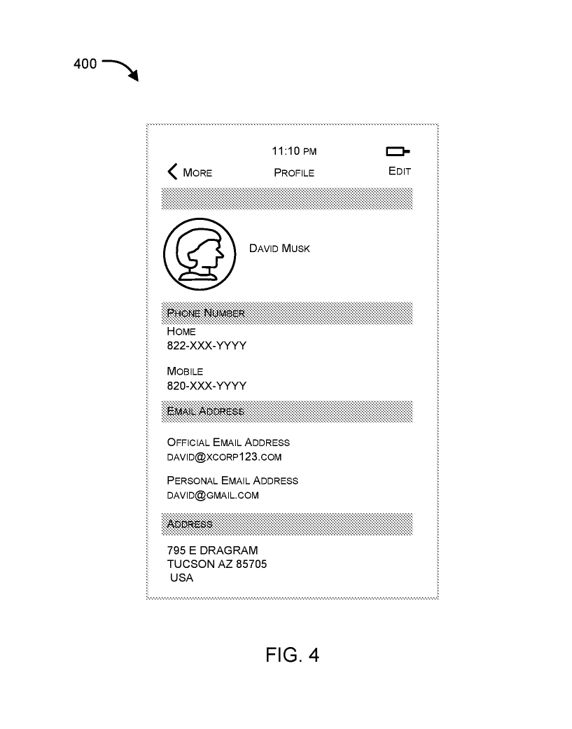

FIG. 4 illustrates an exemplary representation that enables discovery of contact information of a given user across multiple contact directories to enable the user to modify at least one attribute of the discovered contact information in accordance with an embodiment of the present disclosure. FIG. 4 therefore illustrates an exemplary representation 400 that enables discovery of contact information of a given user across multiple contact directories to enable the user to modify at least one attribute of the discovered contact information in accordance with an embodiment of the present disclosure. As can be seen, user A in this instance can be “Akriti Aggarwal”, which can, using the proposed system, discover all the contact information pertaining to her across all shared and/or private contact directories, wherein the discovered contact information is shown in FIG. 4. As can be seen, a notification (shown as question mark) can be shown against the phone number “+91-78978 97998”, which the user can label as a Mobile number or Work number or Home number, or can even discard the number as being old/incorrect. Such updation of the classification/label for the contact attribute “phone number” having value “+91-78978 97998” can then, in real-time, be reflected across all contact directories that store this phone number (contact attribute value) against the user “Akriti Aggarwal”.

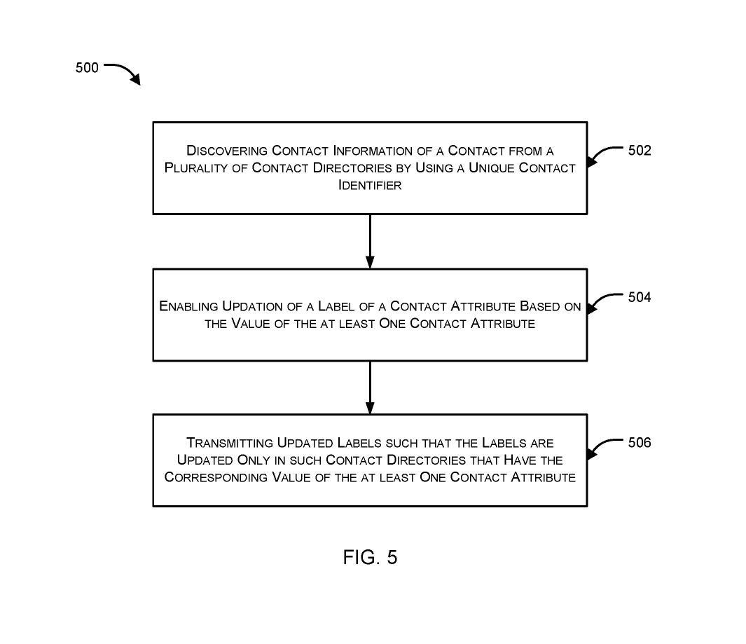

FIG. 5 illustrates a flow diagram showing discovery of contact attribute values of a contact from one or more contact directories based on a unique identifier of the contact, and updation of labels pertaining to contact attributes of the discovered contact attribute values based on the contact attributes of the discovered contact attribute values in accordance with an embodiment of the present disclosure.

As shown, step 502 includes discovering, at a computing device, using a unique identifier of a contact, from a plurality of contact directories storing instances of the unique identifier of the contact, contact information pertaining to the contact, said contact information comprising values for a plurality of contact attributes, wherein said plurality of contact directories storing the unique identifier of the contact comprise at least one crowd sourced shared contact directory having the contact, and wherein the at least one crowd sourced shared contact directory is crowd sourced so as to discover new contacts automatically based on actions of multiple contacts that are already a part of the shared contact directory. Step 504 includes enabling, at the computing device, updation of a label of at least one contact attribute of the plurality of contact attributes based on the value of the at least one contact attribute; and step 506 includes transmitting back, from the computing device, updated labels such that the labels are updated only in such contacts that have the corresponding value of the at least one contact attribute.

It should be appreciated that the modules proposed may be deployed in various configurations like the contacts having the unique identifiers may be directly provided to the device requesting discovery and updating the labels. The device may itself discover attributes, update labels and then propagate to the contacts with the help of a synchronization engine on the cloud.

In another embodiment, a copy of contact profile may be synchronized with all devices that use the contact profile in order to update their own respective labels and discover missing attributes to be added back to the contact profile by a local comparison on their respective devices.

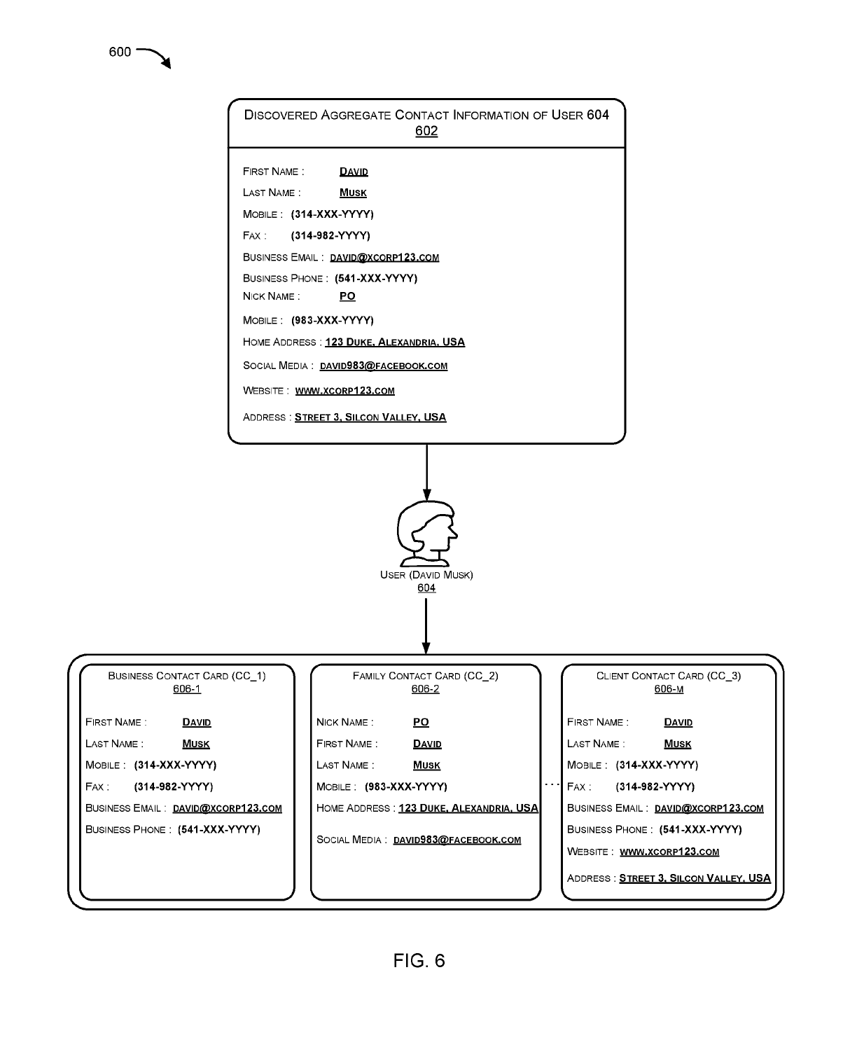

In yet another aspect, discovery of contact information of user A from CDs that user A forms part of or has access to can be used to generate one or more contact cards (CCs) for the user A. For instance, aggregate contact information of user A that is generated/created by discovering all contact information about the user A stored across accessible CDs (private CDs and/or shared CDs) using a unique identifier such as phone number of the user, can be used by the user to select which contact information can be used for which CC. For instance, user A can select first name, last name, work phone number, fax number, and official email address to create a business contact card, and can similarly select first name, last name, personal email address, social media handle, and personal phone number to create a family contact information. Any number of such CCs can therefore be created by a user from the aggregate contact information that the user has discovered, say one for family, one for friends, one for clients, one for office colleagues, one for club colleagues, etc, which CCs may then be shared with one or more users in the respective category. Of course, the user may have an ability to edit/add new contact information to any CC as well. FIG. 6 illustrates an exemplary representation showing how a user David Musk can create one or more CCs using aggregate contact information that he has discovered from a plurality of CDs that he forms part of or has access to. As shown, 602 shows discovered aggregate contact information (like FIG. 3B) pertaining to user 604 (also referred to as David Musk), wherein the from the aggregate contact information 602, one or more CCs 606-1, 606-2, . . . , 606-M can be created automatically/semi-automatically/manually based on which contact information attributes does the user wish to include in each CC 606.

In another aspect, CC's can also be created automatically based on one or more labels that the user may define beforehand. For instance, a user can pre-configure that a business CC should be created automatically based on contact information attributes that have the label of Work/Business such as Work email address, Work Phone number, etc. Once one or more CCs are created automatically, they may be manually verified by the user to confirm that each CC has the intended contact information attributes and values thereof. It may also be possible that post creation of a CC, as and when a user discovers new contact information of himself/herself, CCs having the same contact information attributes are updated automatically or after user authorization.

All the above functionality could also be implemented in the cloud in order to achieve the same purpose and result. Location and placement of modules may be dependent on the language and architecture to code the system and the preference of the person skilled in the art of programming. The technical effect would however remain the same.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

I claim:

1. A system for contact information discovery and discovery-based label updation comprising:
a non-transitory storage device having embodied therein one or more routines operable to facilitate contact discoveryand discovery-based label updation; and
one or more processors coupled to the non-transitory storage device and operable to execute the one or more routines, wherein the one or more routines include:
a contact information discovery module, which when executed by the one or more processors, receives contact information pertaining to a contact, wherein the contact information is discovered using a unique identifier of the contact from a plurality of contact directories that storeinstances of the unique identifier of the contact, said contact information comprising values for a plurality of contact attributes, wherein said plurality of contact directories storing the unique identifier of the contact comprise at least one crowd sourced shared contact directory having the contact, and wherein the at least one crowd sourced shared contact directory is crowd sourced so as to discover new contacts automatically based on actions of multiple contacts that are already a part of the shared contact directory;
a contact information label updation module, which when executed by the one or more processors, enables updation of a label of at least one contact attribute of the plurality of contact attributes based on the value of the at least one contact attribute;
a label update transmission module, which when executed by the one or more processors, transmits the updated label such that the labelis updated only in such contact directories that have the value of the at least one contact attribute.

2. The system of claim 1, wherein the unique identifier is selected from any or a combination of phone number of the user, name of the user, email address of the user, social mediahandle,and a contact identifier associated with the user while registering with the system.

3. The system of claim 1, wherein the plurality of contact attributes are selected from any or a combination of mobile phone number, landline phone number, social media handle, fax number, email address, physical address, first name, last name, middle name, designation, gender, and website link.

4. The system of claim 1, wherein the label updation comprises any or a combination of change of a contact attribute value from valid to invalid, discard action on a contact attribute value, change in type of a contact attribute based on its value, and change in privacy/visibility type of a contact attribute based on its value.

5. The system of claim 1, wherein the contact information label updation module does not allow updation of value of any contact attribute.

6. The system of claim 1, wherein the contact attributes values are processed so as to enable the contact information label updation module to receive only unique contact attribute values.

7. The system of claim 1, wherein at least one of the plurality of contact directories storing instances of the unique identifier of the contact is not shared with the contact.

8. The system of claim 1, wherein the updation of the label is accompanied with association of a graphical representation with the label, said graphical representation being indicative of the updated label being verified by the contact.

9. The system of claim 8, wherein the association comprises adding the graphical representation to the label.

10. The system of claim 8, wherein the graphical representation is a tick mark.

11. The system of claim 1, wherein the contact creates one or more contact cards from the discovered contact information, each said contact card comprising at least one contact information attribute along with a corresponding value.

12. The system of claim 1, wherein the discovered contact information comprises only such contact information that was previously not discovered for the contact.

13. The system of claim 1, wherein theplurality of contact directories comprise only newly discovered contact directories that were unknown when previous discovery step was performed.

14. A method for contact information discovery and discovery-based label updation, said method comprising the steps of:
discovering, at a computing device, using a unique identifier of a contact, from a plurality of contact directories storing instances of the unique identifier of the contact, contact information pertaining to the contact, said contact information comprising values for a plurality of contact attributes, wherein said plurality of contact directories storing the unique identifier of the contact comprise at least one crowd sourced shared contact directory having the contact, and wherein the at least one crowd sourced shared contact directory is crowd sourced so as to discover new contacts automatically based on actions of multiple contacts that are already a part of the shared contact directory;
enabling, at the computing device, updation of a label of at least one contact attribute of the plurality of contact attributes based on the value of the at least one contact attribute; and
transmitting, from the computing device, updated labels such that the labels are updated only in such contact directories that have the corresponding value of the at least one contact attribute.

15. The method of claim 14, wherein the unique identifier is selected from any or a combination of phone number of the user, name of the user, email address of the user, social media handle, and a contact identifier associated with the user while registering with the system.

16. The method of claim 14, wherein the plurality of contact attributes are selected from any or a combination of mobile phone number, landline phone number, social media handle, fax number, email address, physical address, first name, last name, middle name, designation, gender, and website link.

17. The method of claim 14, wherein the label updation comprises any or a combination of change of a contact attribute value from valid to invalid, discard action on a contact attribute value, change in type of a contact attribute based on its value, and change in privacy/visibility type of a contact attribute based on its value.

18. The method of claim 14, wherein the step of enabling the updation of the label does not allow updation of value of any contact attribute.

19. The method of claim 14, wherein before the step of enabling the updation of the label, the contact attributes values are processed so as to enable reception of only unique contact attribute values.

20. The method of claim 14, wherein at least one of the plurality of contact directories storing instances of the unique identifier of the contact is not shared with the contact.

21. The method claim 14, wherein the at least one crowd sourced shared contact directoryis stored at a centralized server that is accessible to all contacts that form part of the the at least one crowd sourced shared contact directory.

22. The method of claim 14, wherein one or more contacts that form part of the contact directories in which updated labels are reflected are intimated when such updation is performed.
